(19) United States
(12) Patent Application Publication
(10) Pub. No.: US 2017/0097459 A1
(43) Pub. Date: Apr. 6, 2017

(54) OPTICAL COMPONENT AND DISPLAY DEVICE INCLUDING THE SAME

(71) Applicant: Samsung Display Co., Ltd., Yongin-Si (KR)

(72) Inventors: Kang-woo LEE, Seoul (KR); Yongkyu KANG, Hwaseong-si (KR); Sunhee OH, Anyang-si (KR); Hyunwoo LEE, Anyang-si (KR)

(21) Appl. No.: 15/182,991

(22) Filed: Jun. 15, 2016

(30) Foreign Application Priority Data
Oct. 1, 2015 (KR) 10-2015-0138730

(51) Int. Cl. F21V 8/00

(52) U.S. Cl. CPC G02B 6/0053; G02B 6/0051; G02B 6/0088

(57) ABSTRACT

A display device includes a display panel, a light source, and an optical component which provides a light from the light source to the display panel, includes a light guide film and an optical sheet, is coupled to the light guide film and includes a base film and optical layers disposed between the base film and the light guide film to control a traveling direction of the light where each of the optical layers overlaps the base film by a first width, each of the optical layers overlaps the light guide film by a second width, the first width is greater than a height of each of the optical layers, and a value obtained by dividing the second width by the first width is greater than about zero (0) and smaller than about 0.2.

This application claims priority to Korean Patent Application No. 10-2015-0138730, filed on Oct. 1, 2015, and all the benefits accruing therefrom under 35 U.S.C. §119, the content of which in its entirety is herein incorporated by reference.

### BACKGROUND

1. Field

Exemplary embodiments of the invention relate to an optical component and a display device including the same. More particularly, exemplary embodiments of the invention relate to an optical component controlling a light traveling direction of a light emitted from a light source and a display device including the optical component.

2. Description of the Related Art

A display device, such as a liquid crystal display device, generally includes a backlight assembly and a display panel displaying an image using a light provided from the backlight assembly. The backlight assembly includes a light emitting unit, a light guide plate, and optical sheets controlling a path of a light exiting from the light guide plate.

The light guide plate guides the light generated by the light emitting unit to the display panel. As the optical sheets, a diffusion sheet and a prism sheet are widely used. The diffusion sheet diffuses the light exiting from the light guide plate, and the prism sheet condenses the light exiting from the light guide plate in a front direction substantially perpendicular to the display panel.

### SUMMARY

Exemplary embodiments of the invention provide an optical component having improved function of controlling a light traveling direction of a light.

Exemplary embodiments of the invention provide a display device including the optical component and having improved display quality.

Exemplary embodiments of the invention provide an optical component including a light guide film and an optical sheet coupled to the light guide film. The light guide film includes an incident surface to which a light is incident and an exit surface from which the incident light exits. The optical sheet includes a base film and optical layers disposed between the base film and the light guide film to control a traveling direction of the light.

In an exemplary embodiment, each of the optical layers may overlap the base film by a first width, each of the optical layers may overlap the light guide film by a second width, the first width may be greater than a height of each of the optical layers, and a value obtained by dividing the second width by the first width may be greater than about zero (0) and smaller than about 0.2.

Exemplary embodiments of the invention provide a display device including a display panel, a light source, and an optical component. The light source emits a light and the display panel displays an image using the light. The optical component provides the light from the light source to the display panel.

In an exemplary embodiment, the optical component may include a light guide film and an optical sheet. The light guide film may guide the light to the display panel. The optical sheet may be coupled to the light guide film and include a base film and optical layers disposed between the base film and the light guide film to control a traveling direction of the light.

In an exemplary embodiment, each of the optical layers may overlap the base film by a first width, each of the optical layers may overlap the light guide film by a second width, the first width may be greater than a height of each of the optical layers, and a value obtained by dividing the second width by the first width may be greater than about zero (0) and smaller than about 0.2.

Exemplary embodiments of the invention provide a display device including a display panel, a light source, and an optical component. The light source emits a light and the display panel displays an image using the light. The optical component provides the light from the light source to the display panel.

In an exemplary embodiment, the optical component may include a light guide film and an optical sheet. The light guide film may guide the light to the display panel. The optical sheet may be coupled to the light guide film.

In an exemplary embodiment, the optical sheet may include an adhesive layer, optical layers, and a base film. The adhesive layer may be disposed on the light guide film. The optical layers may be disposed on the adhesive layer to control a traveling direction of the light and a groove may be defined in a portion of each of the optical layers, which contacts the adhesive layer. The base film may face the adhesive layer such that the optical layers are disposed between the base film and the adhesive layer.

According to the above, the light guide film is integrally formed with the optical sheet as a single unitary and individual unit and the design of the optical layers of the optical sheet is optimized, thereby brightness in the front direction substantially perpendicular to the display panel may be improved.

In addition, since each of the optical layers includes the groove, an adhesive material for the adhesive layer may be prevented from pushed out to a peripheral area of the optical layers when the light guide film is coupled to the optical sheet by the adhesive layer. Therefore, optical characteristics of the light condensing function of the optical component may be prevented from being deteriorated due to the adhesive material.

### BRIEF DESCRIPTION OF THE DRAWINGS

The above and other advantages of the invention will become readily apparent by reference to the following detailed description when considered in conjunction with the accompanying drawings, in which:

FIG. 1 is an exploded perspective view showing an exemplary embodiment of a display device according to the invention;

FIG. 2 is a plan view showing a rear surface of an optical component shown in FIG. 1;

FIG. 3A is a cross-sectional view taken along line I-I′ shown in FIG. 1;

FIG. 3B is a cross-sectional view taken along line II-II′ shown in FIG. 1;

FIG. 4A is an enlarged perspective view showing one of optical layers shown in FIG. 3A;

FIG. 4B is a view showing an optical function of one of optical layers shown in FIG. 3A;

FIGS. 5A and 5B are graphs showing comparison examples of a brightness varied as a function of a viewing angle of a display panel according to the invention;

FIGS. 5C and 5D are graphs showing a brightness varied as a function of a viewing angle of a display panel according to embodiment examples of the invention;

FIG. 6 is a plan view showing another exemplary embodiment of a rear surface of an optical component according to the invention;

FIG. 7A is a cross-sectional view taken along line shown in FIG. 6;

FIG. 7B is an enlarged perspective view showing one of optical layers shown in FIG. 7A;

FIG. 8A is a cross-sectional view showing another exemplary embodiment of an optical sheet according to the invention;

FIG. 8B is an enlarged perspective view showing one of optical layers shown in FIG. 8A; and

FIG. 9 is a cross-sectional view showing another exemplary embodiment of an optical sheet according to the invention.

### DETAILED DESCRIPTION

The following description with reference to the accompanying drawings is provided to assist in a comprehensive understanding of various embodiments of the invention as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the invention. In addition, descriptions of well-known functions and constructions may be omitted for clarity and conciseness.

Moreover, the use of the terms first, second, etc. do not denote any order or importance, but rather the terms first, second, etc. are used to distinguish one element from another. Like numerals refer to like elements throughout. It will be understood that when an element such as a layer, film, region, or substrate is referred to as being “on” another element, it can be directly on the other element or intervening elements may also be present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, the invention will be explained in detail with reference to the accompanying drawings.

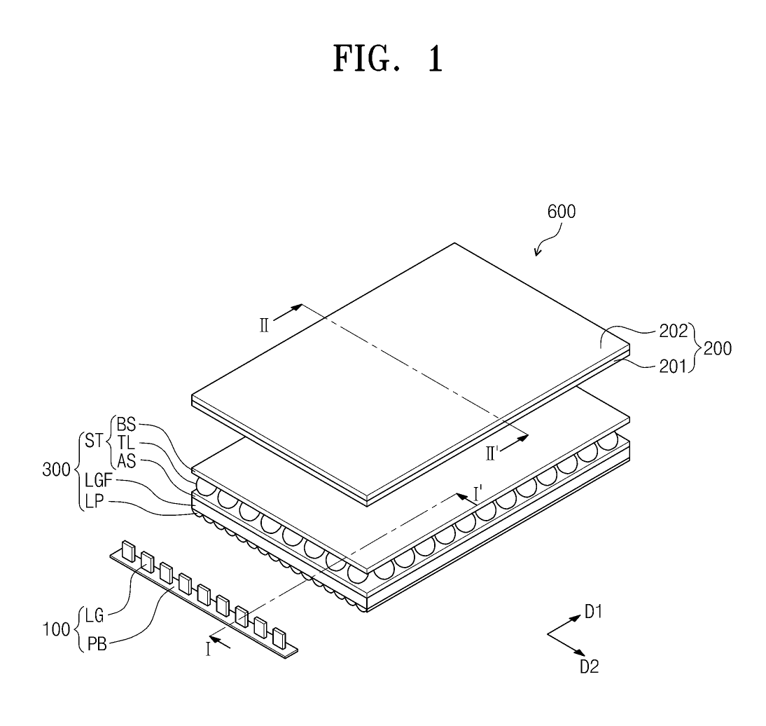

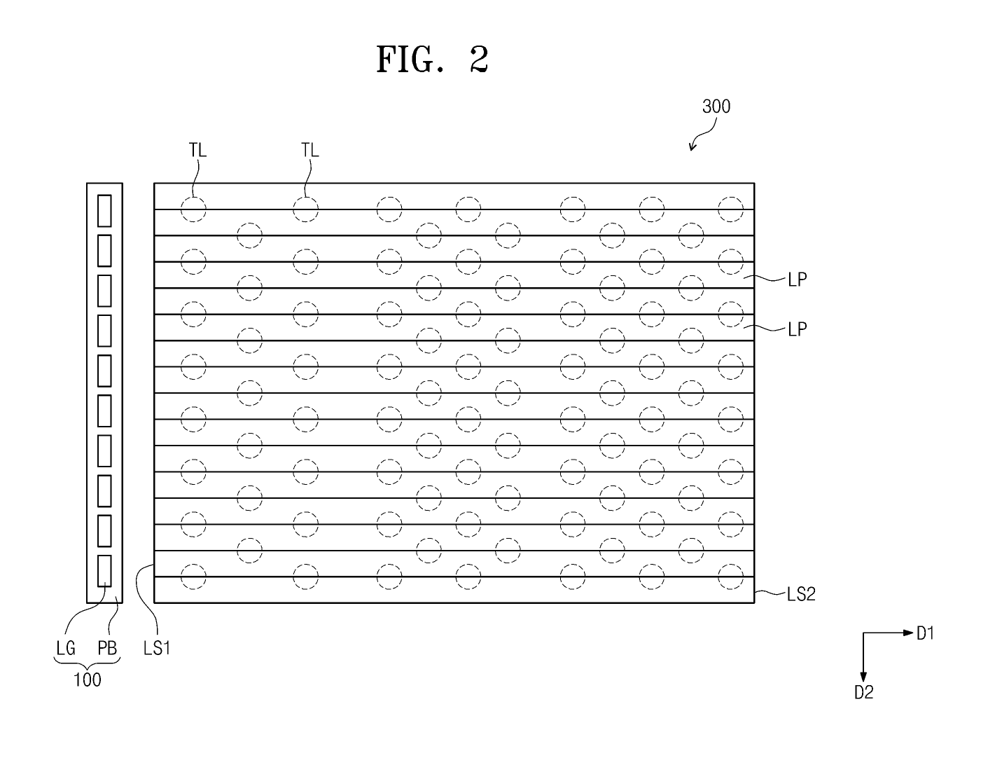

FIG. 1 is an exploded perspective view showing a display device 600 according to an exemplary embodiment of the invention and FIG. 2 is a plan view showing a rear surface of an optical component 300 shown in FIG. 1.

Referring to FIGS. 1 and 2, the display device 600 may be, but not limited to, a liquid crystal display (“LCD”) device and includes a light emitting unit 100, a display panel 200, and an optical member 300.

The display panel 200 displays an image using a light emitted from the light emitting unit 100. In the illustrated exemplary embodiment, the display panel 200 includes a display substrate 201, an opposite substrate 202, and a liquid crystal layer (not shown) interposed between the display substrate 201 and the opposite substrate 202.

The display substrate 201 includes a plurality of pixel electrodes (not shown) arranged to correspond to a plurality of pixel areas in a one-to-one correspondence and the opposite substrate 202 includes a common electrode (not shown) facing the pixel electrodes. However, the structure of the display substrate 201 and the opposite substrate 202 should not be limited thereto or thereby. According to another embodiment, the common electrode may be removed from the opposite substrate 202, and the display substrate 201 may include the common electrode in addition to the pixel electrodes.

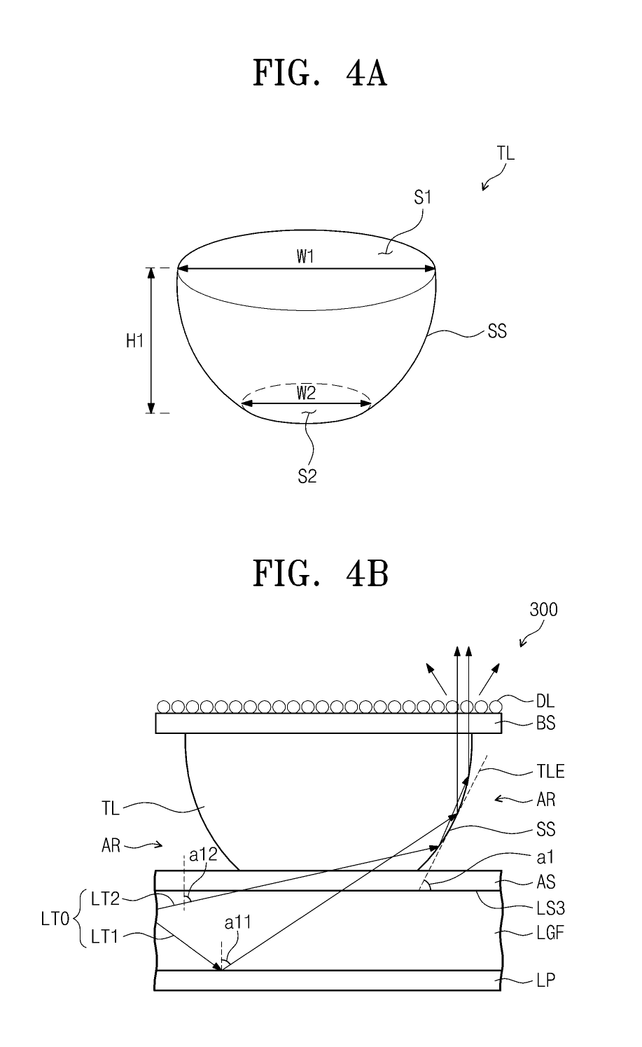

The light emitting unit 100 includes a driving circuit substrate PB and a plurality of light sources LG disposed (e.g., mounted) on the driving circuit board PB. In the illustrated exemplary embodiment, each of the light sources LG may be, but not limited to, a light emitting diode package, and the light sources LG may receive a source voltage from the driving circuit board PB to generate a light LT0 (refer to FIG. 4B).

The light sources LG are arranged along one side of the optical component 300. According to another embodiment, additional light sources may be arranged along the other side of the optical component 300.

The optical component 300 includes a light guide film LGF, light-condensing layers LP, and an optical sheet ST.

The light emitting from the light sources LG is incident to the light guide film LGF and the light guide film LGF guides the light incident thereto to the display panel 200. The light guide film LGF includes an incident surface LS1 to which the light is incident, an opposite surface LS2 facing the incident surface LS1, and an exit surface LS3 (refer to FIG. 4B) from which the light incident to the light guide film LGF exits.

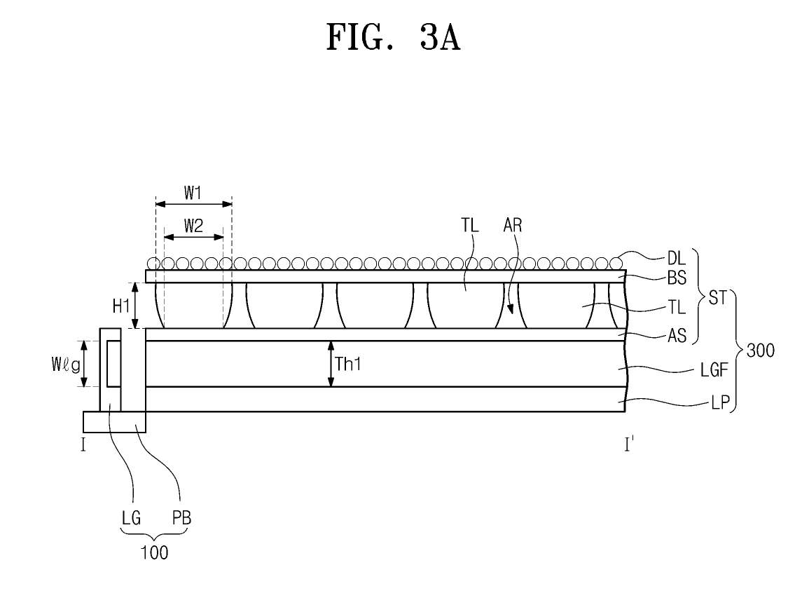

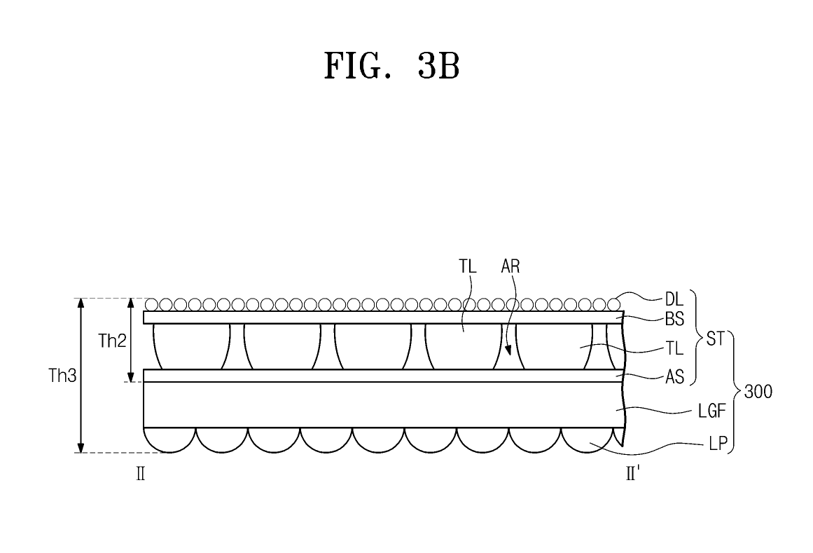

In the illustrated exemplary embodiment, the light guide film LGF includes a polymer material and has a thin film shape, and thus the light guide film LGF has a flexibility. In an exemplary embodiment, the light guide film LGF includes the polymer material, such as polyethylene terephthalate (“PET”), polymethyl methacrylate (“PMMA”), polycarbonate (“PC), etc., for example, and has a thickness Th1 (refer to FIG. 3A) taken along a cross-sectional direction which is perpendicular to the first and second directions D1 and D2 from about 100 micrometers to about 500 micrometers.

In the case where the thickness Th1 of the light guide film LGF is smaller than a width W1g of a light emitting surface of each of the light sources LG taken along the second direction D2, the incident surface LS1 may have a width greater than a width of the opposite surface LS2 or an optical member may be disposed to connect the incident surface LS1 of the light guide film LGF and the light sources LG. Accordingly, an efficiency in which the light emitted from the light sources LG is incident to the light guide film LGF may be improved.

The light-condensing layers LP are disposed on a rear surface of the light guide film LGF. In the illustrated exemplary embodiment, each of the light-condensing layers LP is protruded from the rear surface of the light guide film LGF to refract or reflect a light traveling through the light guide film LGF to a front direction substantially perpendicular to the display panel 200.

Each of the light-condensing layers LP has a prism or lenticular shape. In addition, when a direction from the incident surface LS1 to the opposite surface LS2 is referred to as a first direction D1, each of the light-condensing layers LP extends in the first direction D1.

The rear surface of the light guide film LGF and the opposite surface LS2 may be coated with a reflective layer. Therefore, the light may be prevented from leaking through the rear surface of the light guide film LGF and the opposite surface LS2 by the reflective layer.

The optical sheet ST is coupled with the light guide film LGF and provided with an integral shape. In the illustrated exemplary embodiment, the optical sheet ST includes a base film BS, optical layers TL, and an adhesive layer AS.

In an exemplary embodiment, the base film BS includes a polymer material, e.g., PET, PMMA, PC, etc. The optical layers TL are disposed on the base film BS to contact the light guide film LGF, and thus the light totally reflected in the light guide film LGF exits outward from the optical layers TL. In addition, the light LT0 incident to the optical layers TL through the light guide film LGF is condensed to the front direction substantially perpendicular to the display panel 200.

In the illustrated exemplary embodiment, the optical layers TL are arranged spaced apart from each other when viewed in a plan view and each of the optical layers TL has a dot shape. In FIG. 2, each of the optical layers TL has a substantially a circular dot shape, but it should not be limited thereto or thereby. That is, each of the optical layers TL may have an oval dot shape or a polygonal dot shape.

As described above, since the light totally reflected in the light guide film LGF exits outward from the optical layers TL, an amount of the light exiting from the light guide film LGF through the optical layers TL may be increased as a density of the optical layers TL in the light guide film LGF is increased. Thus, the density of the optical layers TL decreases as a distance from the incident surface LS1 decreases and the density of the optical layers TL increases as a distance from the opposite surface LS2 decreases as shown in FIG. 2.

FIG. 3A is a cross-sectional view taken along line I-I′ shown in FIG. 1 and FIG. 3B is a cross-sectional view taken along line II-II′ shown in FIG. 1.

Referring to FIGS. 3A and 3B, the optical sheet ST is disposed on the light guide film LGF and provided with an integral shape. The light-condensing layers LP are disposed on the rear surface of the light guide film LGF and the adhesive layer AS is disposed on an upper surface of the light guide film LGF. In the illustrated exemplary embodiment, the adhesive layer AS includes a polymer material having a light transmittance, for example. In an exemplary embodiment, the adhesive layer AS may be, but not limited to, an optically clear adhesive (“OCA”), for example.

The optical layers TL are disposed on and adhered to the adhesive layer AS, the base film BS is disposed on the optical layers TL, and a diffusion layer DL is disposed on the base film BS.

In a manufacturing method of the optical component 300 having the above-mentioned structure, the optical layers TL are disposed on one surface of the base film BS and the diffusion layer DL is disposed on the other surface of the base film BS, thereby manufacturing the optical sheet ST. In addition, the light-condensing layers LP are disposed on one surface of the light guide film LGF and the adhesive layer AS is disposed on the other surface of the light guide film LGF. Then, the optical sheet ST is pressurized to the adhesive layer AS disposed on the light guide film LGF to adhere the optical layers TL to the adhesive layer AS. As a result, the optical component 300 is manufactured.

The optical layers TL are disposed between the light guide film LGF and the base film BS and spaced apart from each other, and an air layer AR is interposed between two optical layers TL adjacent to each other. In the illustrated exemplary embodiment, the optical layers TL includes the polymer material, e.g., PET, PMMA, PC, etc., and thus the optical layers TL have a refractive index greater than that of the air layer AR. Accordingly, a total reflection may occur at an interface between the optical layers TL and the air layer AR according to an angle at which the light exiting from the light guide film LGF is incident to the interface between the optical layers TL and the air layer AR.

The diffusion layer DL is disposed on the base film BS and faces the optical layers TL such that the base film BS is disposed between the diffusion layer DL and the optical layers TL. The diffusion layer DL diffuses the light sequentially passing through the optical layers TL and the base film BS. Therefore, the light condensed in the front direction substantially perpendicular to the display panel 200 (refer to FIG. 1) by the optical layers TL is diffused to the front direction by the diffusion layer DL.

In the illustrated exemplary embodiment, the diffusion layer DL includes a binder and diffusion particles distributed in the binder, and the diffusion particles include a semi-transmissive material, such as titanium oxide (TiO₂), aluminum oxide (Al₂O₃), etc., for example.

In an exemplary embodiment, a sum of a thickness Th1 of the light guide film LGF and a thickness Th2 of the optical sheet ST may be in a range of about 100 micrometers to about 1000 micrometers, for example.

Hereinafter, the structure and function of the optical layers TL will be described in detail with reference to FIGS. 4A and 4B.

FIG. 4A is an enlarged perspective view showing one of the optical layers TL shown in FIG. 3A and FIG. 4B is a view showing an optical function of one of the optical layers TL shown in FIG. 3A. In the following descriptions with reference to FIGS. 4A and 4B, only one optical layer of the optical layers TL will be described in detail since the optical layers TL have the same structure and function, and details of the others will be omitted in order to avoid redundancy.

Referring to FIGS. 3A, 4A, and 4B, the optical layer TL includes an upper surface S1, a lower surface S2, and a side surface SS connecting the upper surface S1 and the lower surface S2. The upper surface S1 contacts the base film BS by a first width W1 and the lower surface S2 contacts the adhesive layer AS by a second width W2.

In the illustrated exemplary embodiment, the upper surface S1 may have substantially a circular shape having the first width W1 as its diameter and the lower surface S2 may have substantially a circular shape having the second width W2 as its diameter. In addition, the optical layer TL has a tapered shape. As a distance from the upper surface S1 decreases, the width of the optical layer TL increases, and the width of the optical layer TL decreases as a distance from the lower surface S2 decreases. Therefore, the first width W1 may be a maximum width of the optical layer TL and the second width W2 may be a minimum width of the optical layer TL.

The side surface SS of the optical layer TL contacts the air layer AR. Thus, the light is reflected at the side surface SS due to a difference in refractive index between the optical layer TL and the air layer AR.

In the illustrated exemplary embodiment, the side surface SS has a round shape. In more detail, the side surface SS has the round shape convex to the air layer AR. In an exemplary embodiment, a tangent line TLE of the side surface SS is defined, and an acute angle a1 between the tangent line TLE and the exit surface LS3 is in a range from about 30 degrees to about 70 degrees, for example. However, the acute angle a1 should not be limited thereto or thereby. That is, the acute angel a1 may be changed depending on a size of the light guide film LGF or a distance between the optical layer TL and the light source LG (refer to FIG. 2).

The optical function of the optical layer TL having the above-mentioned structure is as follows. The light LT0 totally reflected in the light guide film LGF is divided into a first light LT1 and a second light LT2. The first light LT1 passes through the adhesive layer AS after being totally reflected in the light guide film LGF and is incident to the optical layer TL at a first incident angle a11.

Since the light guide film LGF, the adhesive layer AS, and the optical layer TL include the polymer material and substantially similar refractive index, the first light LT1 may be minimized from being totally reflected at the interface between the light guide film LGF and the adhesive layer AS and at the interface between the adhesive layer AS and the optical layer TL. Accordingly, most of the first light LT1 may be incident to the optical layer TL after passing through the adhesive layer AS.

After the first light LT1 is incident to the optical layer TL, the first light LT1 is reflected by the side surface SS of the optical layer TL. As described above, the side surface SS contacts the air layer AR and the air layer AR has the refractive index smaller than that of the optical layer TL, and thus the reflection of the first light LT1 may be induced at the side surface SS.

The side surface SS has the round shape convex to the air layer AR. Therefore, when the first light LT1 reaching the side surface SS in an oblique direction with respect to a normal line of the light guide film LGF is reflected by the side surface SS, a traveling direction of the first light LT1 may be changed to the substantially front direction substantially perpendicular to the display panel 200 (refer to FIG. 1). Then, the first light LT1 is diffused while passing through the diffusion layer DL, and as a result, the first light LT1 exits from the optical component 300.

The second light LT2 passes through the adhesive layer AS after being totally reflected in the light guide film LGF and is incident to the optical layer TL at a second incident angle a12, and the second incident angle a12 is greater than the first incident angle a11. In this case, different from the first light LT1, the second light LT2 incident to the optical layer TL may be reflected by the side surface SS multiple times. As the number of reflection of the second light LT2 by the side surface SS increases, a traveling direction of the second light LT2 may be close to the front direction substantially perpendicular to the display panel.

Different from the illustrated exemplary embodiment, in the case where the side surface SS is flat, the second light LT2 is reflected once by the side surface and exits from the optical component 300 at an exit angle similar to the second incident angle a12, and thus the condensing effect of the optical layer TL may be deteriorated. However, in the case where the side surface SS has the round shape, the condensing effect of the second light LT2 may be improved by the optical layer TL since the second light LT2 is reflected by the side surface SS multiple times and the traveling direction of the second light LT2 is more close to the front direction substantially perpendicular to the display panel.

In the illustrated exemplary embodiment, the first width W1, the second width W2, and a height H1 of the optical layer TL satisfy the following Equation 1 and Equation 2.

0<H1/W1<1.0 Equation 1

0<W2/W1<0.2 Equation 2

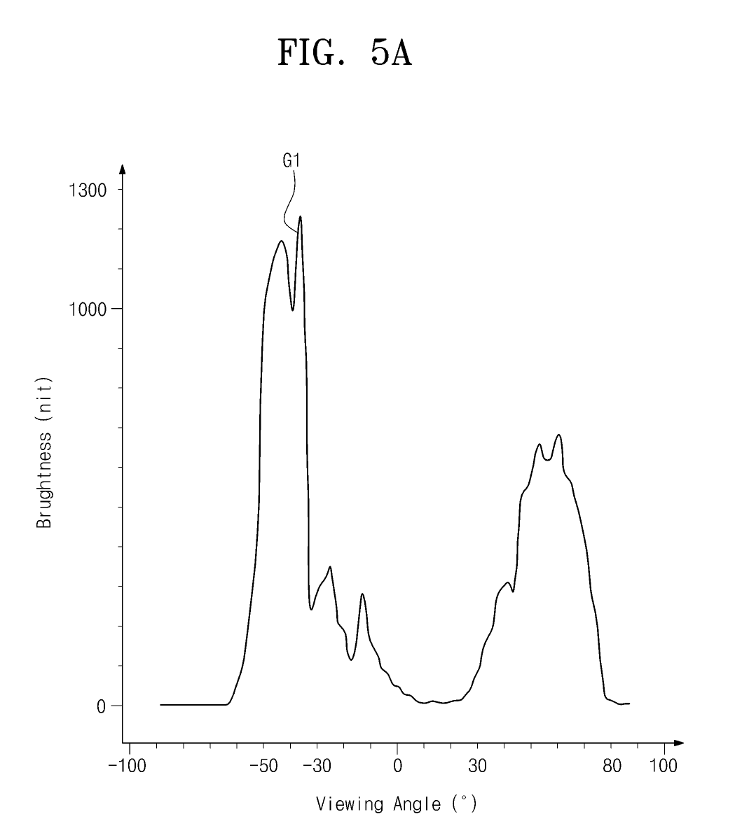

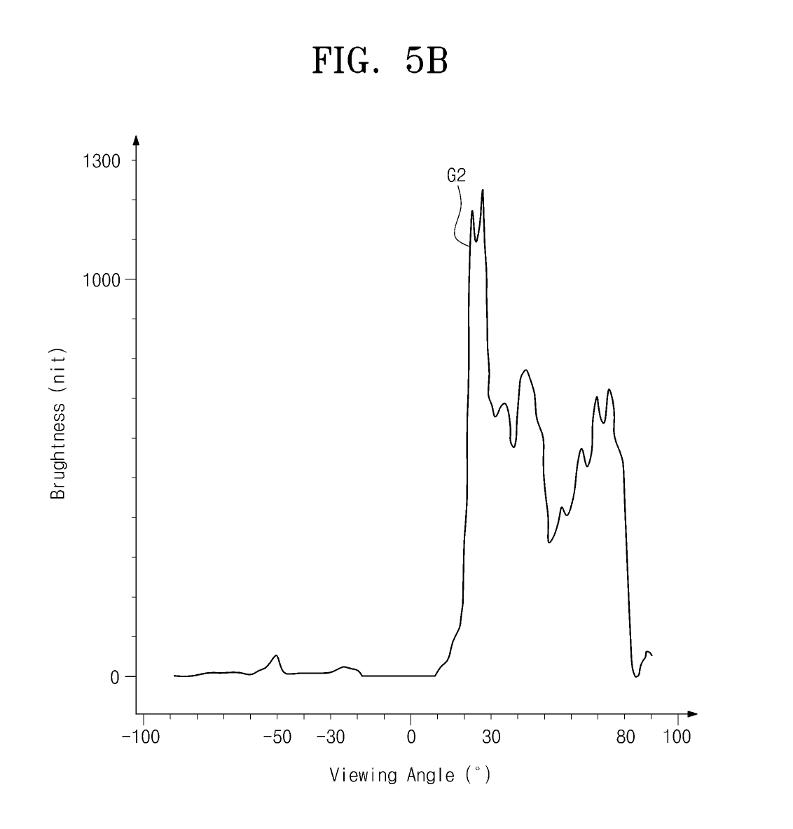

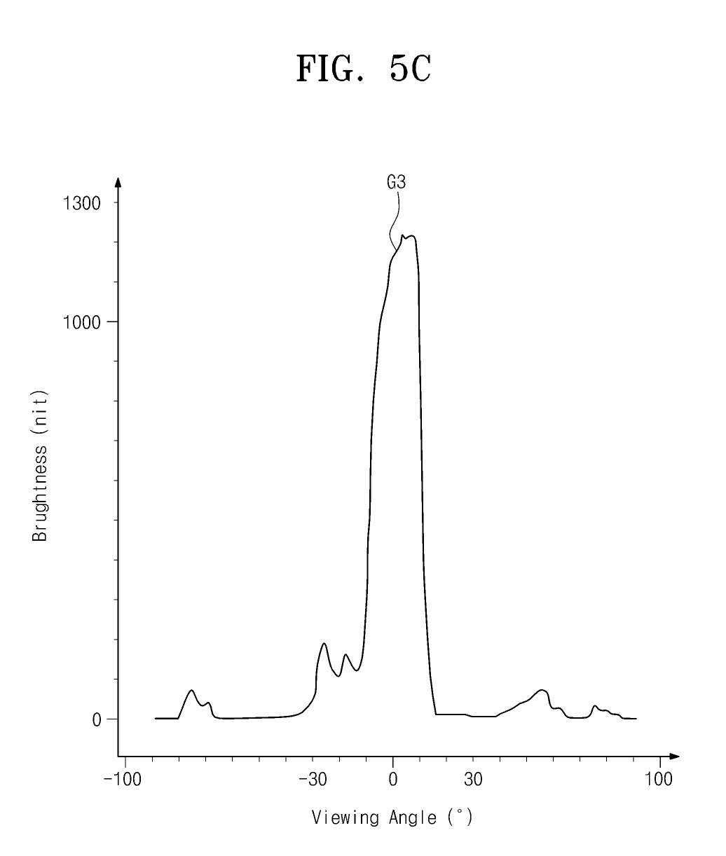

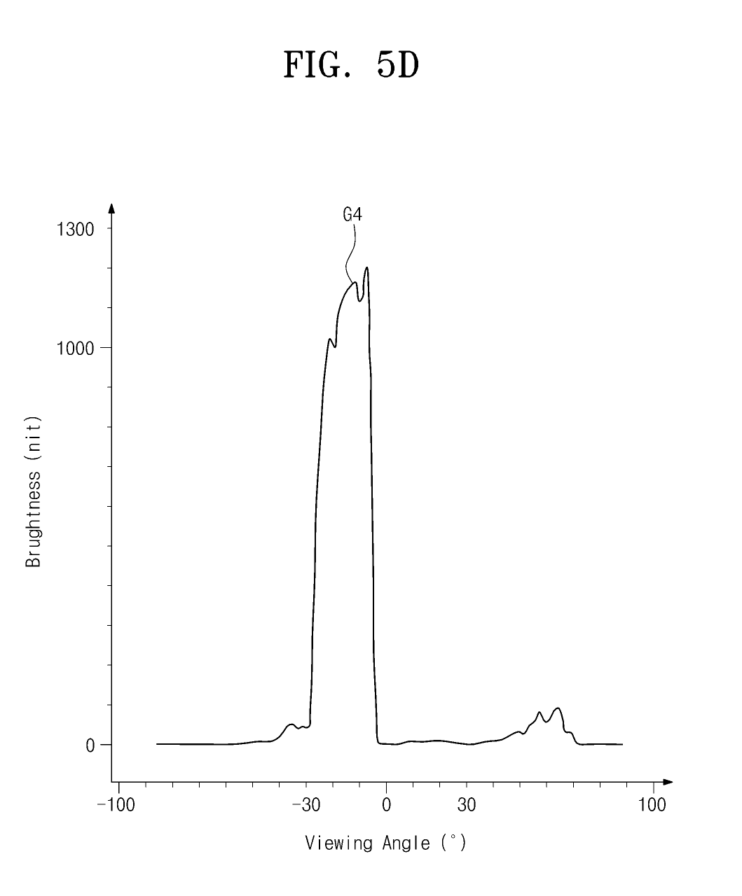

In the case where the optical layer TL is designed to satisfy Equation 1 and Equation 2, the effect in which the light LT0 is condensed in the front direction substantially perpendicular to the display panel may be maximized by the optical layer TL. This will be described in detail with reference to FIGS. 5A and 5D.

FIGS. 5A and 5B are graphs showing a brightness varied as a function of a viewing angle of a display panel according to comparison examples of the invention and FIGS. 5C and 5D are graphs showing a brightness varied as a function of a viewing angle of a display panel according to embodiment example of the invention. In more detail, FIGS. 5A and 5B respectively show first and second graphs G1 and G2 to represent a relation between the viewing angle and the brightness of the display panel when the optical layer TL does not satisfy Equations 1 and 2, and FIGS. 5C and 5D respectively show third and fourth graphs G3 and G4 to represent a relation between the viewing angle and the brightness of the display panel when the optical layer TL satisfies Equations 1 and 2.

TABLE 1

| | W1 | W2 | H1 | H1/W1 | W2/W1 |
|---|---|---|---|---|---|
| Comparison | 34 μm | 7.6 μm | 36 μm | 1.06 | 0.22 |
| example 1 | | | | | |
| Comparison | 34 μm | 13.6 μm | 51 μm | 1.50 | 0.40 |
| example 2 | | | | | |
| Embodiment | 34 μm | 5.0 μm | 23 μm | 0.68 | 0.15 |
| example 1 | | | | | |
| Embodiment | 34 μm | 6.1 μm | 27 μm | 0.79 | 0.18 |
| example 2 | | | | | |

Referring to FIGS. 4B and 5A, as represented by the first graph G1 and Table 1, in the case where the design of the optical layer TL does not satisfy Equations 1 and 2, no peak of the brightness exists in the neighborhood of the viewing angle of about 0 degrees and the peak of the brightness exists in the neighborhood of the viewing angle from about −50 degrees to about −40 degrees and the viewing angle from about +60 degrees to about +70 degrees.

In addition, referring to FIGS. 4B and 5B, as represented by the second graph G2 and Table 1, in the case where the design of the optical layer TL satisfies Equations 1 and 2, the peak of the brightness exists between the viewing angle of about +20 degrees and the viewing angle of about +80 degrees.

Since the viewing angle of about 0 degrees means the front direction substantially perpendicular to the display panel, the brightness in a lateral direction of the display panel may be greater than the brightness in the front direction substantially perpendicular to the display panel, and thus the effect in which the light LT0 is condensed in the front direction substantially perpendicular to the display panel by the optical layer TL is not large.

Referring to FIGS. 4B and 5C, as represented by the third graph G3 and Table 1, in the case where the design of the optical layer TL satisfies Equations 1 and 2, the peak of the brightness exists between the viewing angle of about −10 degrees and the viewing angle of about +10 degrees.

Referring to FIGS. 4B and 5D, as represented by the fourth graph G4 and Table 1, in the case where the design of the optical layer TL satisfies Equations 1 and 2, the peak of the brightness exists between the viewing angle of about −20 degrees and the viewing angle of about 0 degrees. Accordingly, in the case where the optical layer TL is designed to satisfy Equations 1 and 2 according to the illustrated exemplary embodiment, a range of the viewing angle becomes close to about 0 degrees, and thus the brightness in the front direction substantially perpendicular to the display panel may be greater than the brightness in the lateral direction of the display panel. This means that the effect in which the light LT0 is condensed in the front direction substantially perpendicular to the display panel by the optical layer TL is improved.

A first ratio of the first height H1 and the first width W1 and a second ratio of the second width W2 and the first width W1 may be changed depending on the thickness Th3 (refer to FIG. 3B) of the optical component. Therefore, different from the illustrated exemplary embodiment, in the case where the thickness Th3 of the optical component is not considered, the first ratio satisfying Equation 1 and the second ratio satisfying Equation 2 are difficult to be obtained, and as a result, it is difficult to design the optical layer TL to allow the brightness in the front direction substantially perpendicular to the display panel to be maximized. However, in the case where the optical component has the thickness Th3 from about 100 micrometers to about 1000 micrometers, the first ratio may be easily obtained in the range satisfying Equation 1 and the second ratio may be easily obtained in the range satisfying Equation 2. Thus, the optical layer TL may be easily designed to allow the brightness in the front direction substantially perpendicular to the display panel to be maximized.

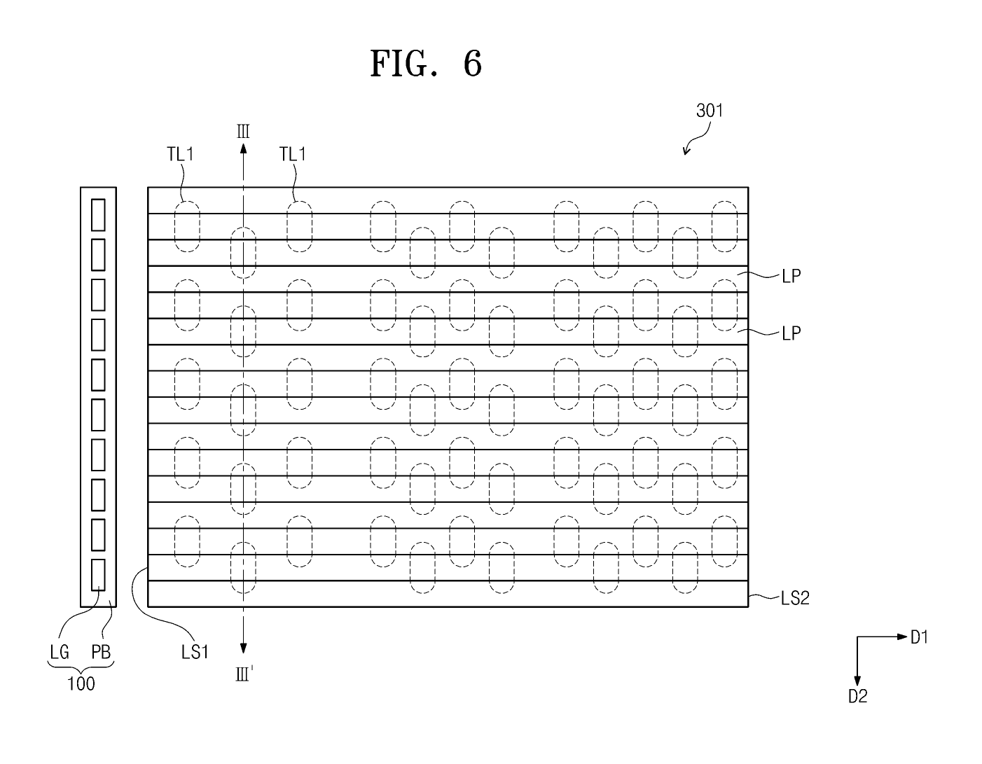

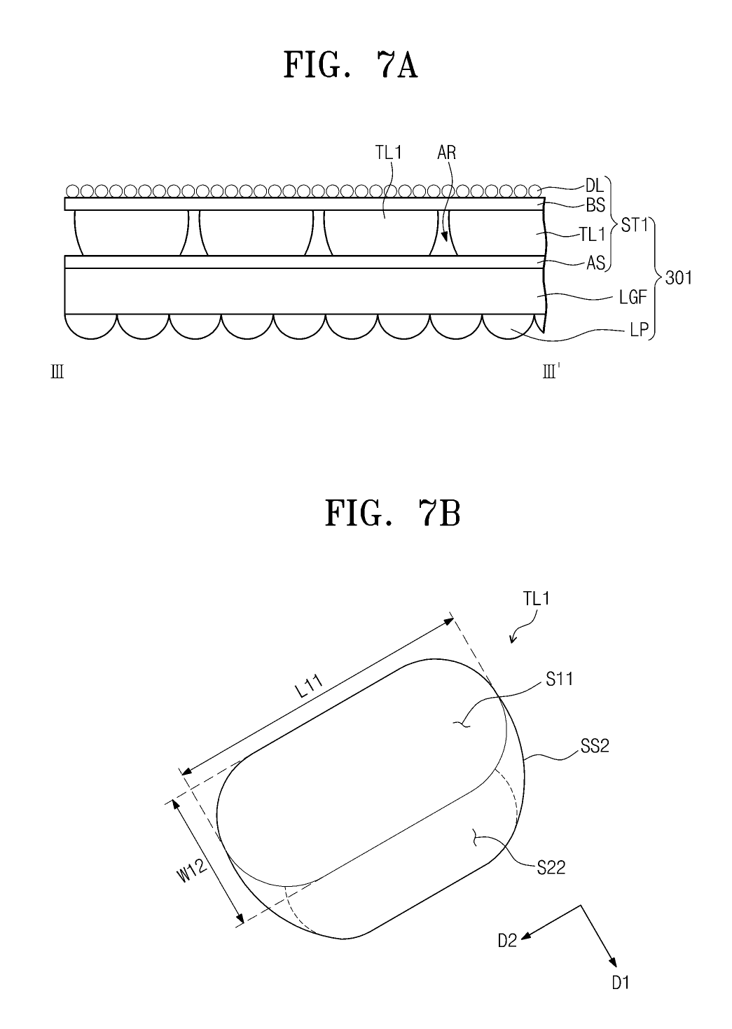

FIG. 6 is a plan view showing a rear surface of an optical component 301 according to another exemplary embodiment of the invention, FIG. 7A is a cross-sectional view taken along line shown in FIG. 6, and FIG. 7B is an enlarged perspective view showing one of optical layers shown in FIG. 7A. In FIGS. 6, 7A, and 7B, the same reference numerals denote the same elements in the early mentioned embodiments, and thus detailed descriptions of the same elements will be omitted.

Referring to FIGS. 6, 7A, and 7B, the optical component 301 includes a light guide film LGF, light-condensing layers LP, and an optical sheet ST1, and the optical sheet ST1 includes a base film BS, optical layers TL1, and an adhesive layer AS. The optical layers TL1 have the same structure and function with each other, and thus only one optical layer TL1 of the optical layers TL1 will be described in detail.

In the illustrated exemplary embodiment, the optical layer TL1 includes an upper surface S11, a lower surface S22, and a side surface SS2 connecting the upper surface S11 and the lower surface S22. A lengthwise direction of each of the upper and lower surfaces S11 and S22 is substantially parallel to a second direction D2 and a widthwise direction of each of the upper and lower surfaces S11 and S22 is substantially parallel to a first direction D1. That is, the optical layer TL (refer to FIG. 4A) has the dot shape when viewed in a plan view as shown in FIG. 2, but the optical layer TL1 according to the illustrated exemplary embodiment has an elongated shape. Accordingly, the lengthwise direction and the widthwise direction may be defined in each of the upper and lower surfaces S11 and S22. When a length L11 of the upper surface S11 is defined in the second direction D2 and a width W12 of the upper surface S11 is defined in the first direction D1, a ratio of the width to the length is in a range of about 1.0:2.5 to about 1.0:3.5, for example.

Table 2 shown below a viewing angle range corresponding to a half of a maximum peak of brightness of the display panel according to the ratio of the width to the length, and the viewing angle range indicates a sum of a left side viewing angle and a right side viewing angle or an upper side viewing angle and a lower side viewing angle. In addition, as the viewing angle range decreases, the effect in which the light is condensed in the front direction substantially perpendicular to the display panel by the optical layer TL1 is improved.

TABLE 2

| | Width:Length | | | | |
|---|---|---|---|---|---|
| | 1.0:1.0 | 1.0:1.5 | 1.0:2.0 | 1.0:3.0 | 1.0:4.0 |
| Range of | 24 degrees | 23 degrees | 23 degrees | 19 degrees | 29 degrees |
| viewing | | | | | |
| angle | | | | | |

Referring to Table 2 and FIG. 7B, when the ratio of the width W12 to the length L11 of the optical layer TL1 is in a range of about 1.0:1.0 to about 1.0:1.5 or about 1.0:4.0, the viewing angle range exceeds about 23 degrees. In addition, when the ratio of the width W12 to the length L11 of the optical layer TL1 is in a range of 1.0:3.0, the viewing angle range is about 19 degrees. This means that the effect in which the light is condensed in the front direction substantially perpendicular to the display panel by the optical layer TL1 is maximized when the ratio of the width W12 to the length L11 is in the range of about 1.0:2.5 to about 1.0:3.5.

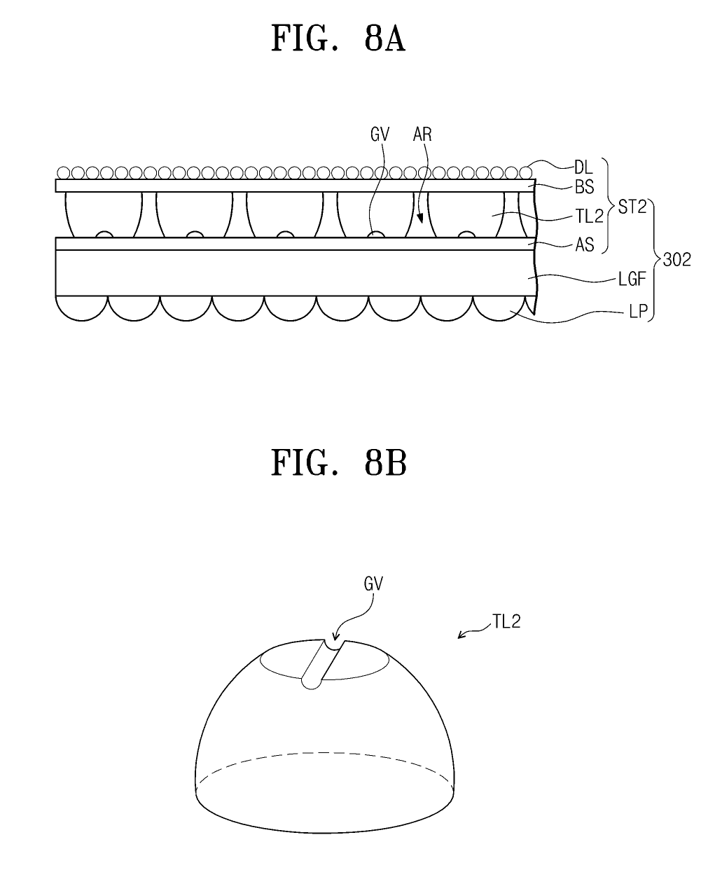

FIG. 8A is a cross-sectional view showing an optical component 302 according to another exemplary embodiment of the invention and FIG. 8B is an enlarged perspective view showing one of optical layers shown in FIG. 8A. In FIGS. 8A and 8B, the same reference numerals denote the same elements in the early described embodiments, and thus detailed descriptions of the same elements will be omitted.

Referring to FIGS. 8A and 8B, the optical component 302 includes a light guide film LGF, light-condensing layers LP, and an optical sheet ST2, and the optical sheet ST2 includes a base film BS, optical layers TL2, and an adhesive layer AS. The optical layers TL2 have the same structure and function with each other, and thus only one optical layer TL2 will be described in detail.

In the illustrated exemplary embodiment, a groove GV is defined in a portion of the optical layer TL2, which contacts the adhesive layer AS. Since a lower surface S2 of the optical layer TL2 contacts with the adhesive layer AS, the groove GV is defined by removing a portion of the optical layer TL2 from the lower surface S2.

As described above, in the manufacturing method of the optical component 302, the light guide film LGF having the light-condensing layers LP is manufactured, the adhesive layer AS is provided between the optical sheet ST2 and the light guide film LGF, and then the optical sheet ST2 is pressurized to the light guide film LGF, thereby attaching the optical sheet ST2 to the light guide film LGF.

Different from the illustrated exemplary embodiment, in the case where the lower surface S2 has a flat shape when the optical sheet ST2 is pressurized to the light guide film LGF, an adhesive material for the adhesive layer AS contacting the lower surface S2 of the optical layer TL2 is pushed out to a peripheral area of the optical layer TL2, and the adhesive material pushed out to the peripheral area of the optical layers TL2 may be randomly stuck around the optical layer TL2. In this case, the light refracted or reflected by the adhesive material may randomly travel in various direction, and as a result, the brightness in the front direction substantially perpendicular to the display panel is deteriorated.

However, according to the illustrated exemplary embodiment, since the groove GV is defined in the lower surface S2 of the optical layer TL2, the adhesive material is accommodated in the groove GV. Therefore, the adhesive material is prevented from being pushed out to the peripheral area of the optical layer TL2, so that the brightness in the front direction substantially perpendicular to the display panel is prevented from being deteriorated.

In the illustrated exemplary embodiment, at least one side of the groove GV is opened. Thus, when the optical sheet ST2 is attached to the light guide film LGF, the adhesive material and bubbles may be easily discharged to the outside of the optical layers TL2 through the groove GV.

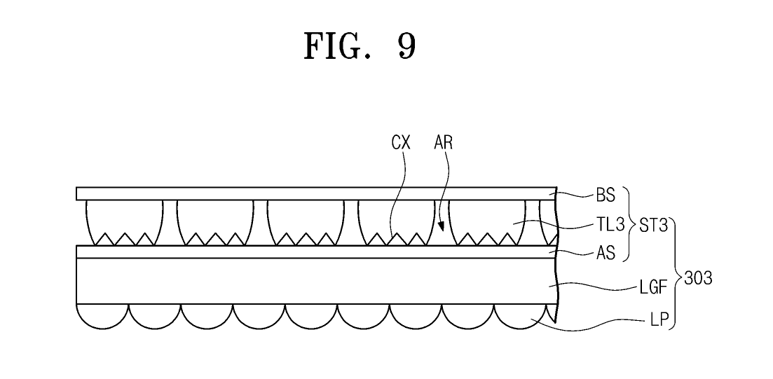

FIG. 9 is a cross-sectional view showing an optical component 303 according to another exemplary embodiment of the invention. In FIG. 9, the same reference numerals denote the same elements in the early described embodiment, and thus detailed description of the same elements will be omitted in order to avoid redundancy.

Referring to FIG. 9, the optical component 303 includes a light guide film LGF, light-condensing layers LP, and an optical sheet ST3, and the optical sheet ST3 includes a base film BS, optical layers TL3, and an adhesive layer AS.

In the illustrated exemplary embodiment, each of the optical layers TL3 includes a concavo-convex pattern CX provided in a portion of each of the optical layers TL3, which contacts the adhesive layer AS. The concavo-convex pattern CX may be provided by defining the groove GV (refer to FIG. 8A) described above to each of the optical layers TL3 in a plural number.

As described with reference to FIGS. 8A and 8B, although the adhesive material of the adhesive layer AS flows by the pressurization force applied to the optical sheet ST3 toward the light guide film LGF, the flowing adhesive material is accommodated in grooves defined by the concavo-convex pattern CX. Accordingly, the adhesive material is prevented from being pushed out to the peripheral area of the optical layer TL2, so that the brightness in the front direction substantially perpendicular to the display panel is prevented from being deteriorated.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A display device comprising:
a display panel;
a light source which emits a light; and
an optical component which provides the light provided from the light source to the display panel, the optical component comprising:
a light guide film which guides the light to the display panel; and
an optical sheet which is coupled to the light guide film, comprises a base film and optical layers disposed between the base film and the light guide film and controls a traveling direction of the light,
wherein each of the optical layers overlaps the base film by a first width, each of the optical layers overlaps the light guide film by a second width, the first width is greater than a height of each of the optical layers, and a value obtained by dividing the second width by the first width is greater than about zero (0) and smaller than about 0.2.

2. The display device of claim 1, wherein a ratio of a width to a length in each of the optical layers is in a range of about 1.0:2.5 to about 1.0:3.5.

3. The display device of claim 2, wherein the light guide film comprises an incident surface facing the light source and an opposite surface facing the incident surface, a widthwise direction of each of the optical layers is substantially parallel to a first direction toward the opposite surface from the incident surface when viewed in a plan view, and a lengthwise direction of each of the optical layers crosses the first direction when viewed in the plan view.

4. The display device of claim 3, wherein the optical component comprises light-condensing layers protruded from a rear surface of the light guide film and each of the light-condensing layers having a lengthwise direction along the first direction when viewed in the plan view.

5. The display device of claim 1, wherein
the optical sheet further comprises an adhesive layer disposed between the optical layers and the light guide film to adhere the optical layers to the light guide film, and
a groove is defined in a portion of each of the optical layers, which contacts the adhesive layer.

6. The display device of claim 1, wherein the optical layers are arranged between the light guide film and the base film and spaced apart from each other, and an air layer is defined between two optical layers of the optical layers adjacent to each other.

7. The display device of claim 6, wherein a side surface of each of the optical layers, which contacts the air layer, has a round shape convex to the air layer.

8. The display device of claim 1, wherein the optical sheet further comprises a diffusion layer disposed on the base film.

9. The display device of claim 1, wherein the optical component has a thickness from about 100 micrometers to about 1000 micrometers.

10. A display device comprising:
a display panel;
a light source which emits a light; and
an optical component which provides the light provided from the light source to the display panel, the optical component comprising:
a light guide film which guides the light to the display panel; and
an optical sheet coupled to the light guide film, the optical sheet comprising:
an adhesive layer disposed on the light guide film;
optical layers which is disposed on the adhesive layer to control a traveling direction of the light; and
a base film facing the adhesive layer such that the optical layers are disposed between the base film and the adhesive layer,
wherein a groove is defined in a portion of each of the optical layers, which contacts the adhesive layer.

11. The display device of claim 10, wherein each of the optical layers comprises a concavo-convex pattern defined in a portion thereof, which contacts the adhesive layer.

12. The display device of claim 10, wherein the optical layers are arranged between the light guide film and the base film and spaced apart from each other, and an air layer is defined between two optical layers of the optical layers adjacent to each other.

13. The display device of claim 12, wherein a side surface of each of the optical layers, which contacts the air layer, has a round shape convex to the air layer.

14. The display device of claim 10, wherein the optical sheet further comprises a diffusion layer disposed on the base film.

15. The display device of claim 10, wherein each of the optical layers overlaps the base film by a first width, each of the optical layers overlaps the light guide film by a second width, the first width is greater than a height of each of the optical layers, and a value obtained by dividing the second width by the first width is greater than about zero (0) and smaller than about 0.2.

16. The display device of claim 10, wherein a ratio of a width to a length in each of the optical layers is in a range of about 1.0:2.5 to about 1.0:3.5.

17. The display device of claim 16, wherein the light guide film comprises an incident surface adjacent to the light source and an opposite surface facing the incident surface, a widthwise direction of each of the optical layers is substantially parallel to a first direction toward the opposite surface from the incident surface when viewed in a plan view, and a lengthwise direction of each of the optical layers crosses the first direction when viewed in the plan view.

18. The display device of claim 17, wherein the optical component further comprises light-condensing layers protruded from a rear surface of the light guide film and each of the light-condensing layers having a lengthwise direction along the first direction when viewed in the plan view.

19. The display device of claim 10, wherein the optical component has a thickness from about 100 micrometers to about 1000 micrometers.

20. An optical component comprising:
a light guide film comprising an incident surface to which a light is incident and an exit surface from which the incident light exits; and
an optical sheet which is coupled to the light guide film, comprises a base film and optical layers disposed between the base film and the light guide film and controls a traveling direction of the light,
wherein each of the optical layers overlaps the base film by a first width, each of the optical layers overlaps the light guide film by a second width, the first width is greater than a height of each of the optical layers, and a value obtained by dividing the second width by the first width is greater than about zero (0) and smaller than about 0.2.

21. The optical component of claim 20, wherein a ratio of a width to a length in each of the optical layers is in a range of about 1.0:2.5 to about 1.0:3.5.

22. The optical component of claim 21, wherein the light guide film comprises an opposite surface facing the incident surface, a widthwise direction of each of the optical layers is substantially parallel to a first direction toward the opposite surface from the incident surface when viewed in a plan view, and a lengthwise direction of each of the optical layers crosses the first direction when viewed in the plan view.

23. The optical component of claim 22, further comprising light-condensing layers protruded from a rear surface of the light guide film and each having a lengthwise direction along the first direction when viewed in the plan view.

24. The optical component of claim 20, wherein the optical sheet further comprises:
an adhesive layer disposed between the optical layers and the light guide film to adhere the optical layers to the light guide film; and
a diffusion layer disposed on the base film, and
a groove defined in a portion of each of the optical layers, which contacts the adhesive layer.

25. The optical component of claim 20, wherein the optical layers are arranged between the light guide film and the base film and spaced apart from each other, and an air layer is defined between two optical layers of the optical layers adjacent to each other.

26. The optical component of claim 25, wherein a side surface of each of the optical layers, which contacts the air layer, has a round shape convex to the air layer.

27. The optical component of claim 25, wherein a sum of a thickness of the light guide film and a thickness of the optical sheet is in a range of about 100 micrometers to about 1000 micrometers.
